(19) United States
(12) Patent Application Publication
(10) Pub. No.: US 2021/0096861 A1
(43) Pub. Date: Apr. 1, 2021

(54) SYSTEM AND METHOD TO PREFETCH POINTER BASED STRUCTURES

(71) Applicant: HIGON AUSTIN R&D CENTER, Austin, TX (US)

(72) Inventors: Hao WANG, Cedar Park, TX (US); Fei CHEN, Austin, TX (US); Leigang KOU, Austin, TX (US)

(73) Assignee: HIGON AUSTIN R&D CENTER, Austin, TX (US)

(21) Appl. No.: 16/589,706

(22) Filed: Oct. 1, 2019

(51) Int. Cl. G06F 9/30; G06F 9/48; G06F 9/32; G06F 9/38

(52) U.S. Cl. CPC G06F 9/30047; G06F 9/4881; G06F 9/3867; G06F 9/30043; G06F 9/321

(57) ABSTRACT

A pointer prefetching engine includes a scheduler, a linker, a stride engine, and a prefetch request queuer. The scheduler receives a wakeup based on a load instruction loading data to a memory address identified by a pointer, identifies a dependent instruction based on the wakeup, and validates the dependent instruction. The linker identifies a producer-consumer pair of instructions including the load instruction and the dependent instruction based on the validation of the dependent instruction, and generates a training request based on the producer-consumer pair of instructions. The stride engine determines a regular repeated stride of the producer-consumer pair of instructions based on the training request, and generates a producer prefetch request based on the regular repeated stride. The prefetch request queuer determines an address based on the pointer, modifies the address, and generates a prefetch request for the dependent instruction including the modified virtual address.

### BACKGROUND

### 1. Technical Field

The present disclosure relates to a system and method to prefetch pointer array structures in a computing environment.

### 2. Technical Background

Memory access latency typically causes the waste of hundreds of processor cycles and often becomes a major performance bottleneck. This problem is commonly referred to as the “memory wall.”

Related approaches taken to alleviate this problem include caching and prefetching. Caching is a method of using a hardware cache memory (“cache”) for a central processing unit (CPU) of a computer to reduce the average cost (such as time or energy) to access data. A cache is a smaller, faster memory, closer to a processor core, which stores copies of the data from frequently used main memory locations. Caching takes advantage of this temporal and spatial locality. In other words, caching uses a cache that is quickly accessible to a processing core because the cache is both fast at transferring data and is located near to a processing core. Cache memory may be built into the die of a CPU core for this reason. Related approaches use a memory hierarchy of different types of memory, each level of the memory hierarchy being faster and closer to the CPU processing core. This approach balances the cost of the memory with the performance of the system, because memory that is faster and closer to the processing core is typically more expensive.

Prefetching is a process that attempts to predict the data or instructions that will be accessed by the processor in the future, and prepares the data in advance so that the data is ready when needed by the processor. In other words, prefetching optimizes the use of a memory hierarchy by bringing data from slower memory into faster memory in advance. A method of prefetching can be implemented as a prefetch engine.

However, many programs use pointers to facilitate a dynamic construction of data objects. A pointer is a programming language object that stores the memory address of another data object located in computer memory. Data objects referenced by pointers may be difficult to prefetch because the memory address associated with the dynamically allocated data object usually does not have a regular or predictable pattern. This unpredictable pattern of the pointer is true even when the pointers used in the dynamically allocated data objects are themselves organized in a regular or predictable manner. For example, a program may have an array of pointers where each pointer points to an object that is allocated and/or reallocated during execution of the program. Hence, accesses to the pointer itself would have a sequential pattern, but accesses to the objects pointed to by the pointers will not have an easily prefetchable pattern. Because the memory addresses of data pointed to by pointers cannot be determined by existing prefetching engines, prefetching for instructions accessing objects pointed to by pointers was unavailable, resulting in the waste of processor cycles due to stalling caused by waiting for memory access (the memory wall).

### SUMMARY

The present disclosure is directed to a prefetching engine that can prefetch data blocks for instructions accessing data pointed to by pointers, thereby increasing the efficient use of the available processor cycles by lowering access times for data.

For a central processing unit (CPU) to operate on data in main memory, the data is copied into registers. A load instruction is a memory instruction for copying data from the main memory into a register. A load instruction includes a destination register and a source address in the main memory, and the data at the source address is moved to the destination register upon execution of the load instruction by the processor. Conversely, a store instruction is a memory instruction for copying data from a register into the main memory. A store instruction includes a source register and a destination address in main memory, and the data in the source register is moved to the destination address when the store instruction is executed. A cache can be implemented between the main memory and the registers in a memory hierarchy to expedite access to the main memory, and help overcome the memory wall. A prefetcher can utilize several prefetch engines to help predict memory accesses to data blocks in a variety of situations, and bring the predicted data blocks into the cache in advance.

Prefetch engines train on past memory accesses, predict the address of future memory accesses based on the training, and attempt to access and transfer the predicted memory address into the cache in advance. Hardware prefetch engines often use tables to record the information of past memory accesses, and use the data in the table as training. For example, related prefetch engines analyze the address history associated with a static instruction or a group of instructions stored in a table to find a regular pattern of address histories associated by a static instruction or group of instructions. A static instruction is an instruction found in a program, and can be uniquely identified by its program counter (PC), which is an example of the address of the associated instruction.

A dynamic instruction is an instance of a static instruction found during execution. Dynamic instructions having the same PC can exhibit a particular behavior repeatedly, and can therefore be predictable. For example, a looped set of instructions will find each iteration of each instruction in the loop accessing data at a fixed distance from the previous iteration. This distance is commonly referred to as a “stride.” In other words, memory accesses having a repetitive stride can be easily predicted. However, this can be complicated when the source and destination memory addresses of load and store instructions are implemented as pointers for the reasons explained above.

In a first embodiment, a prefetching engine according to the present disclosure includes an enhanced scheduler, a producer-consumer linker, a pointer-producer queuer, an enhanced stride prefetch engine, and a pointer prefetch request queuer.

The enhanced scheduler can identify a dependent instruction and generate a consumer-candidate-valid signal indicating that the dependent instruction is a consumer candidate, and send the consumer-candidate-valid signal to the producer-consumer linker.

The producer-consumer linker can receive the consumer-candidate-valid signal from the enhanced scheduler, identify a producer, generate a training request based on the consumer-candidate-valid signal, and send the training request to the stride engine. A producer is a load instruction. The training request includes a producer's program counter, a virtual address of the producer, and a displacement of a dependent instruction. The consumer instruction (the previously identified consumer candidate) is a load instruction or a store instruction that (i) executes subsequently to the producer, and (ii) depends on the data loaded by the producer to calculate an address of the consumer. In other words, although there other types of dependent instructions, such as arithmetic instructions, the consumer is a memory instruction having an address that is calculated dependent upon the data loaded by the producer (e.g., produced by the producer). Generating the training request includes reading a piece of data from the source address of the producer, the piece of data being a pointer (the producer produces a pointer). The producer-consumer linker can send the training request to the pointer-producer queuer.

The pointer-producer queuer can receive the training request, and store the training request until the stride engine is ready to process the training request. A benefit of the pointer-producer queuer is allowing a plurality of load instructions (producers) to be accepted for training that are detected in a single cycle. Because the stride engine may be limited to training one stride request at a time, the pointer-producer queuer provides the benefit of allowing the system to handle a plurality of training requests that result from a single cycle. In other words, the pointer-producer queuer allows asynchronous handling of training requests.

When the stride engine is ready to train, the stride engine can receive the training request, and determine whether the producer has a regular repeated stride between which the producer loads memory addresses. A stride is a distance in memory addresses between an iteration of an instruction and a subsequent iteration of the same instruction. A regular repeated stride is a stride that is consistent between memory accesses of subsequent iterations of the same instruction. In addition, the stride engine can generate a producer prefetch request, and send the producer prefetch request including a virtual address of a predicted producer and the displacement of a predicted consumer to the pointer prefetch request queuer.

The producer prefetch request queuer can receive the producer prefetch request, send the producer lookup request to a memory lookup pipeline, and generate a consumer prefetch request based on the data response from producer prefetch request. The memory lookup pipeline responds to the producer lookup request by providing a return data, which is interpreted as a virtual address in memory that the pointer of the producer pointed to. The producer prefetch request queuer can generate a consumer prefetch request by adding the displacement of the consumer to the returned virtual address of the producer. The producer prefetch request queuer can then send the consumer prefetch request to a prefetch request queue for prefetching the data needed to execute the consumer.

A benefit of the first embodiment is that prefetching can be accomplished for instructions accessing objects pointed to by pointers. This increases the efficiency of the processor by avoiding the waste of processor cycles by decreasing access times for data.

In a first alternative embodiment of the first embodiment, the stride engine can generate a plurality of producer prefetch requests when a regular repeated stride is found. The stride engine can determine a depth ahead of demand requests issued by actual instructions at which the stride engine will generate producer prefetch requests, and then generate producer prefetch requests for the determined depth. Demand requests are issued by actual instructions. The producer prefetch requests are generated by the stride engine before the demand requests to retrieve data to cover the data requested by the demand requests, and therefore reduce latency, and address the issue of the memory wall. The stride engine of the first alternative embodiment of the first embodiment can generate a first producer prefetch request in the same manner as the first embodiment described above. In addition, the stride engine generates each subsequent producer prefetch request by sequentially incrementing the index of the virtual address by the regular repeated stride. The stride engine can generate subsequent producer prefetch requests to the determined depth.

A benefit of this first alternative embodiment of the first embodiment is that producer prefetch requests can be generated sooner, thus further decreasing memory access times for the predicted subsequent iterations of the producer and the consumer.

In a second alternative embodiment, the producer-consumer linker can send the training request directly to the stride engine, and the pointer-producer queuer is removed from the pointer engine.

A benefit of this second alternative embodiment is increased efficiency in environments where only one load instruction is processed per processor cycle.

### BRIEF DESCRIPTION OF THE DRAWINGS

FIG. 1 is a schematic diagram of a prefetcher.

FIG. 2 is a schematic diagram of a pointer prefetching engine for a prefetcher.

FIG. 3 is a schematic example of a scheduler queue.

FIG. 4 is a schematic example of scheduler signals.

FIG. 5 is a schematic example of a pointer-producer queue.

FIG. 6 is a schematic example of a stride table.

FIG. 7 is a flowchart illustrating an example of a flow of a pointer engine.

FIG. 8 is a flowchart illustrating an example of a flow for linking a producer and a consumer.

FIG. 9 is a flowchart illustrating an example of a flow for training producer-consumer pairs in a stride engine.

FIG. 10 is a flowchart illustrating an example of a flow for prefetching for a producer and for prefetching for a consumer.

### DETAILED DESCRIPTION OF EMBODIMENTS

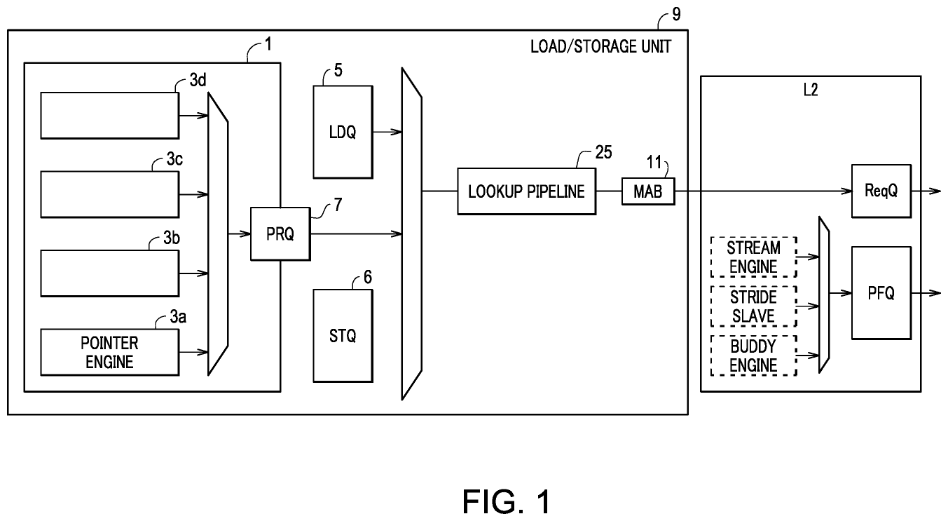

As illustrated in FIG. 1, a prefetcher 1 can be implemented in a load/store unit 9. The prefetcher 1 includes at least a prefetching engine 3a, and a prefetch request queue 7. Memory lookup requests, such as prefetch requests, that miss in L1 cache are sent to L2 cache through a miss address buffer 11. When more than one prefetching engine is implemented in the prefetcher 1, such as prefetching engines 3a-3d, and the prefetching engines 3a-3d may be implemented in parallel, such that each of the prefetch engines 3a-3d sends prefetch requests to the same prefetch request queue 7. The prefetch request queue 7 is a queue from which prefetch requests are picked to flow down a memory lookup pipeline 25 of the load/store unit 9. The memory lookup pipeline 25 is an arrangement of hardware elements of a central processing unit (CPU) that allows simultaneous execution of more than one memory lookup request in sequential stages. The load/store unit 9 stores instructions in the load queue 5 and the store queue 6. Upon reaching the end of the memory lookup pipeline 25, a memory lookup is completed, and data stored at a memory location indicated by a request from one of a load queue 5, a store queue 6, and the prefetch request queue 7 is prepared for use with execution of an instruction during processing by a processor.

A person having ordinary skill in the art will recognize that the load queue 5 and the store queue 6 can alternatively be implemented as a single load store queue, and that the number of prefetching engines can be any number greater than or equal to 1. For exemplary purposes of this disclosure, the number of prefetching engines has been selected to be 4.

Exemplary embodiments of a pointer prefetching engine 3a for a prefetcher 1 are described below in detail.

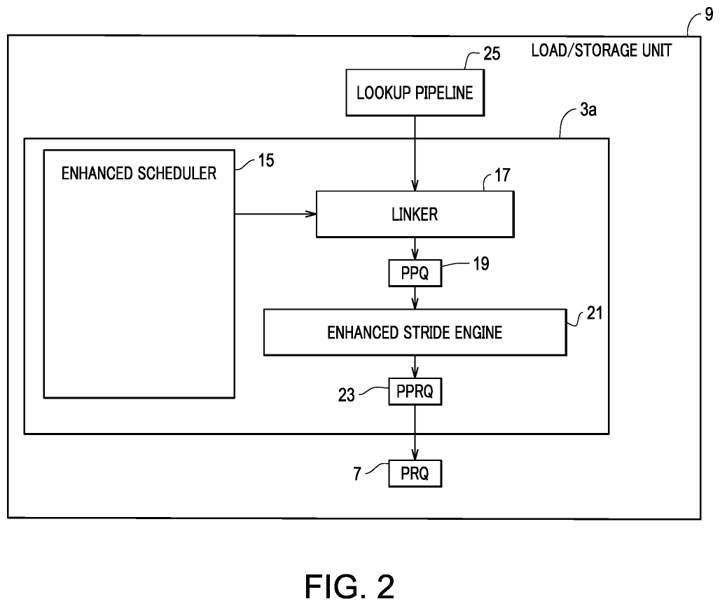

In a first embodiment of the pointer prefetching engine 3a illustrated in FIG. 2, the pointer prefetching engine 3a includes an enhanced scheduler 15, a producer-consumer linker 17, a pointer-producer queuer 19, an enhanced stride prefetch engine 21, and a pointer prefetch request queuer 23.

The enhanced scheduler 15 is responsible for scheduling instructions for execution. The enhanced scheduler 15 can be a processor with a memory, or implemented as a specialized execution unit of a central processing unit with a memory. For instruction scheduling purposes, the enhanced scheduler 15 tracks whether an instruction is ready to execute, such as whether source operands of the instruction are ready. The enhanced scheduler 15 can receive a wakeup signal from the load/store unit 9 when a load instruction having a load virtual memory address enters a memory lookup pipeline 25 of the load/store unit 9.

The load instruction has a program counter (PC) that identifies the load instruction, a register name that identifies the register that the load instruction is loading data to. The wakeup signal received by the enhanced scheduler 15 instructs the enhanced scheduler 15 to search for a dependent instruction. The wakeup signal includes the destination register name of the load instruction. A dependent instruction is an instruction subsequent to the load instruction. The dependent instruction is one of a load instruction having a source address that is indicated by a pointer based on the register index of the load instruction of the wakeup signal, and a store instruction having a destination address that is indicated by a pointer based on the register index of the load instruction of the wakeup signal. The load/store unit 9 speculatively sends the wakeup signal to the enhanced scheduler 15 for a predetermined number of cycles (e.g., two cycles) before the load instruction will be ready for processing because the enhanced scheduler 15 requires multiple processor cycles (e.g., two cycles) to schedule a dependent instruction for execution using the data given by the load instruction.

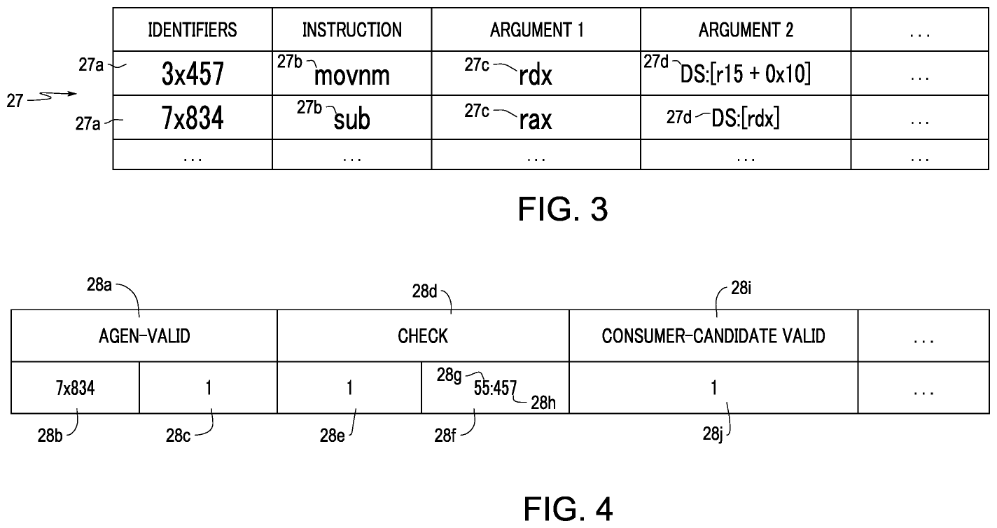

The wakeup signal includes a destination register index of the load instruction. The wakeup signal indicates to the enhanced scheduler 15 that the included destination register will be ready to use in a pre-defined number of process cycles. As would be understood in light of this disclosure, the wakeup signal can be sent speculatively, thus the indication that the destination register will be ready can also be speculative. Consequently, the enhanced scheduler 15 determines instructions that are dependent on the destination register index may be ready to execute. The enhanced scheduler 15 includes a scheduler queue 27, which includes an instruction waiting for execution that reads the register index to which the load instruction is loading data. As shown in FIG. 3, the scheduler queue 27 associates an instruction identifier 27a, instruction 27b, a first argument 27c, and a second argument 27d. Upon receipt of the wakeup signal, the enhanced scheduler 15 searches for the dependent instruction in the scheduler queue 27.

Upon the enhanced scheduler 15 finding the dependent instruction in the scheduler queue 27, and when the dependent instruction is a load or store instruction, the enhanced scheduler 15 wakes up the dependent instruction by issuing the instruction for address calculation, and generating an agen-valid signal 28a. The agen-valid signal 28a is for notifying the load/store unit 9 that the destination/source address of the dependent instruction may be calculated and ready for cache/memory lookup in a predetermined number of process cycles. As shown in FIG. 4, the agen-valid signal 28a includes an identifier 28b of the dependent instruction and a 1-bit valid signal 28c. The form of this identifier 28b is implementation dependent and orthogonal to this invention, for example, it can be the entry index of the load queue 5 or the store queue 6. The enhanced scheduler 15 then sends the agen-valid signal 28a to the load/store unit 9. Upon receipt of the agen-valid signal 28a, the load/store unit 9 marks the load instruction in the load queue 5 as ready for cache/memory lookup, the load instruction having already been entered into the load queue 5 upon entry of the dependent instruction by the load/store unit 9. The load instruction originates from an instruction decode and dispatch unit.

Also in response to the enhanced scheduler 15 finding the dependent instruction in the scheduler queue 27, the enhanced scheduler 15 generates a check status signal 28d. As shown in FIG. 4, the check status signal 28d includes a 1-bit need-check signal 28e and the location 28f of the load instruction. The 1-bit need-check signal 28e indicates whether the agen-valid signal 28a sent in the same cycle is speculative, and hence needs additional confirmation. The location 28f of the load instruction can be in the form of a pipeline index 28g and a pipeline stage 28h. The enhanced scheduler 15 sends the check status signal 28d to the load/store unit 9. Upon receipt of the check status signal 28d, the load/store unit 9 checks the status of the load instruction. A control logic in the load/store unit 9 checks whether the load instruction in the designated stage of the designated pipeline successfully load the data from cache into the destination register. The load/store unit 9 checks the status of the load instruction to determine whether the dependent instruction is still ready for cache/memory lookup. If the load instruction does not successfully load the data, due to for example a L cache miss, the dependent instruction is cancelled for execution because the address of the load instruction (from which the dependent instruction depends) is confirmed to not be ready.

Further in response to the enhanced scheduler 15 finding the dependent instruction in the scheduler queue 27, the enhanced scheduler 15 can inspect a syntax of the arguments 27c and 27d of the dependent instruction by parsing the destination address out from the syntax of the arguments 27c and 27d of the dependent instruction. The enhanced scheduler 15 determines whether the destination address is a simple address. A simple address is an address that includes a register name and a constant displacement. Upon determining that the destination address is a simple address, the enhanced scheduler 15 generates a consumer-candidate-valid signal 28i. The consumer-candidate-valid signal 28i indicates that the dependent instruction is a valid candidate to be a consumer. In other words, the consumer-candidate-valid signal 28i confirms that the dependent instruction is appropriate for pointer prefetching. As shown in FIG. 4, the consumer-candidate-valid signal 28i can be a 1-bit signal 28j. After generating the consumer-candidate-valid signal 28i, the enhanced scheduler 15 sends the consumer-candidate-valid signal 28i to the load/store unit 9.

Although the agen-valid signal 28a, the check status signal 28d, and the consumer-candidate-valid signal 28i are described above as independent of each other, the enhanced scheduler 15 can integrate any combination of the agen-valid signal 28a, the check status signal 28d, and the consumer-candidate-valid signal 28i into a single message sent to the load/store unit 9.

Upon the producer-consumer linker 17 receiving the agen-valid signal 28a, the check status signal 28d, and the consumer-candidate-valid signal 28i, the producer-consumer linker 17 links a producer and a consumer. The producer-consumer linker 17 can be a processor, or implemented as a specialized execution unit of a central processing unit. The producer-consumer linker 17 can access the load queue 5 and the store queue 6, receive the agen-valid signal 28a, the check status signal 28d, and the consumer-candidate-valid signal 28i like the load/store unit 9, and be integrated in the load-store unit 9. As mentioned above, a producer is an instruction that loads data from memory at a virtual memory address pointed to by a pointer; in other words, the loaded data with respect to the pointer of the producer will be used as a virtual memory address by a consumer. Hereinafter, the loaded data with respect to the pointer of the producer will be referred to as a virtual address of the producer. A consumer is an instruction that accesses the data in the memory at the virtual memory address pointed to by the pointer in the producer. A producer-consumer pair includes a producer correlated with a consumer.

Upon the producer-consumer linker 17 receiving the agen-valid signal 28a from the enhanced scheduler 15, the producer-consumer linker 17 identifies the dependent instruction as a consumer in a producer-consumer pair. Similarly, upon the producer-consumer linker 17 receiving the check status signal 28d from the enhanced scheduler 15, the producer-consumer linker 17 identifies the load instruction as a producer in the producer-consumer pair. Upon the producer-consumer linker 17 receiving the consumer-candidate-valid signal 28i from the enhanced scheduler 15, the producer-consumer linker 17 is thereby notified that the producer-consumer pair is a valid candidate for training the enhanced stride prefetch engine 21.

Upon notification that the producer-consumer pair is a valid candidate, the producer-consumer linker 17 generates a training request. A training request includes the PC of the producer, the virtual address of the producer, and the displacement of the consumer. The producer-consumer linker 17 can retrieve the program counter (PC) and the virtual address of the producer from the load queue 5, and determine the displacement of the consumer after inspecting the syntax of the consumer. More specifically, the producer-consumer linker 17 determines a displacement of the consumer by parsing the syntax of the arguments 27c and 27d of the consumer instruction. For reasons that would be apparent in light of this disclosure, using the displacement for the training request in this non-limiting first embodiment increases the efficiency of the pointer prefetching engine 3a.

Upon the producer-consumer linker 17 determining the displacement of the consumer, the producer-consumer generates the training request including the retrieved PC of the producer, the retrieved virtual address of the producer, and the determined displacement of the consumer. The producer-consumer linker 17 then sends the training request to the pointer-producer queuer 19.

The pointer-producer queuer 19 queues training requests. The pointer-producer queuer 19 can be a processor with a memory, or implemented as a specialized execution unit of a central processing unit with a memory. The pointer-producer queuer 19 includes a pointer-producer queue 29 that can sequentially list a plurality of training requests in the order the training requests are received from the producer-consumer linker 17. The pointer-producer queuer 19 receives the training request from the producer-consumer linker 17, and enters the training request into the pointer-producer queue 29.

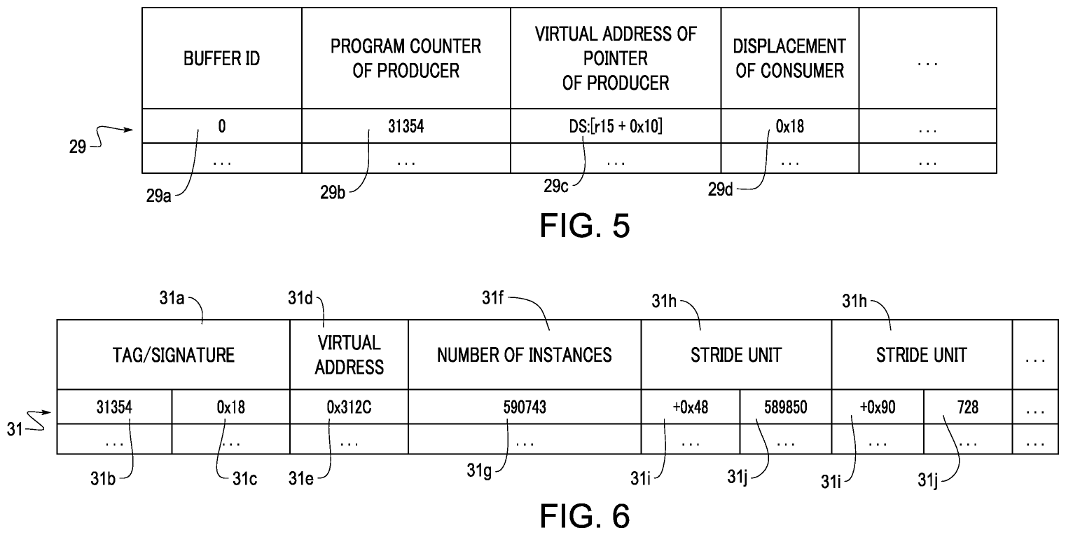

By non-limiting example, the pointer-producer queuer 17 can be a circular first-in-first-out (FIFO) queue implemented as a circular buffer. As shown in FIG. 5, the pointer-producer queue 29 can associate a buffer ID 29a assigned to each training request, the PC 29b of the producer, the virtual address of the producer 29c, and the displacement of consumer 29d of each training request received from the producer-consumer linker 17. The pointer-producer queuer 17 can sequentially send each training request stored in the pointer-producer queue 29 to the enhanced stride prefetch engine 21 in the order that each training request was received to enhanced stride prefetch engine 21.

As would be apparent in light of this disclosure, the benefits of the pointer-producer queuer 17 include allowing a plurality of producers to be accepted for training that are detected in a single cycle, and enabling asynchronous operation of the enhanced stride prefetch engine 21. In other words, because the enhanced stride prefetch engine 21 may train one stride request at a time, the pointer-producer queuer provides the benefit of allowing the system to handle a plurality of training requests that result from a plurality of producers processed in a single processor cycle.

The enhanced stride prefetch engine 21 determines a stride of the producer. The enhanced stride prefetch engine 21 can be a processor with a memory, or implemented as a specialized execution unit of a central processing unit with a memory. The enhanced stride prefetch engine 21 includes a stride table 31 as shown in FIG. 6. Each entry of the stride table includes a tag/signature 31a as an identifier. The tag/signature 31a of each entry includes a PC 31b of an instruction and a displacement 31c. Each entry in the stride table 31 also includes a virtual address 31d, a number of instances 31f the identified instruction has been processed by the stride engine 31, and at least one stride unit 31h associated with the identified instruction. Each entry in the stride table 31 can have a plurality of stride units 31h. Each stride unit 31h includes a per-PC stride 31i and a frequency of the per-PC stride 31j. Upon receiving the training request from the pointer-producer queuer 19, the enhanced stride prefetch engine 21 searches the tag/signatures 31a of the stride table 31 for a tag/signature 31a simultaneously having the PC of the producer of the received training request and the displacement of the received training request.

If the enhanced stride prefetch engine 21 does not find a matching tag/signature 31a in the stride table 31, the enhanced stride prefetch engine 21 allocates a new entry in the stride table 31. An identifier of the new entry includes the PC of the producer and the displacement of the consumer, as a tag/signature of the new entry. In addition, the enhanced stride prefetch engine 21 stores and associates the virtual address of the pointer of the producer in a field of the new entry as a virtual address 31d having a memory address value 31e.

If the enhanced stride prefetch engine 21 finds a matching tag/signature 31a in the stride table 31, this indicates that the enhanced stride prefetch engine 21 has now received a training request for the producer-consumer pair for at least the second time. The enhanced stride prefetch engine 21 then calculates a current stride by comparing the virtual address of the producer included in the training request to the virtual address 31d associated with the matching tag/signature 31a. By non-limiting example, the current stride may be calculated by subtracting the associated virtual address 31d from the virtual address included in the training request. The enhanced stride prefetch engine 21 then increments the number of instances 31f associated with the matching tag/signature 31a, replaces the virtual address 31d with the virtual address included in the training request, and compares the current stride with the per-PC stride(s) 31g of the stride unit(s) 31f associated with the matching tag/signature 31a. The number of instances 31f is a numeric value 31g.

If a matching per-PC stride 31i is found in the stride table 31, the frequency of the per-PC stride 31j associated with the matching stride unit 31h is incremented by 1. When no matching per-PC stride 31i is found in the stride table 31, a new stride unit 31h is added associated with the matching tag/signature 31a to the stride table 31. The new stride unit 31h includes the current stride as the per-PC stride 31i, and the associated frequency 31h is initialized at a value of 1.

The enhanced stride prefetch engine 21 then determines whether a regular repeated stride has been found. By non-limiting example, the enhanced stride prefetch engine 21 can determine whether a regular repeated stride has been found by determining whether the absolute value of a frequency of the incremented per-PC stride 31j is greater than a predetermined threshold value. In an alternative non-limiting example, the enhanced stride prefetch engine 21 can determine whether a regular repeated stride has been found by determining whether a ratio of the frequency of the incremented per-PC stride 31j to an associated number of instances 31f is greater than a predetermined threshold ratio. As made apparent in light of this disclosure, other appropriate approaches to determining whether a regular repeated stride has been found can be implemented by the enhanced stride prefetch engine 21.

When the enhanced stride prefetch engine 21 determines a regular repeated stride has been found, the enhanced stride prefetch engine 21 generates a producer prefetch request, and sends the producer prefetch request to the producer prefetch request queuer 23. The producer prefetch request is a request to read the pointer value from memory in advance of an actual producer instruction. After sending the producer prefetch request to the pointer prefetch request queuer 23, the enhanced stride prefetch engine 21 obtains a subsequent training request from the pointer-producer queuer 19.

The producer prefetch request is based on the virtual address of the pointer of the producer and also includes the displacement of the consumer, as received with the training request. The pointer prefetch request queuer 23 receives the producer prefetch request from the enhanced stride prefetch engine 21. The pointer prefetch request queuer 23 can be a processor with a memory, or implemented as a specialized execution unit of a central processing unit with a memory. The pointer prefetch request queuer 23 includes a producer prefetch request queue 33. The pointer prefetch request queuer 23 inserts a new entry into the pointer prefetch request queue 33 including the virtual address and the displacement included in the producer prefetch request.

As shown in FIG. 6, each entry of the pointer prefetch request queue 33 associates a virtual address 33a and a displacement 33b. The pointer prefetch request queuer 23 can use the oldest entry of the pointer prefetch request queue 33 to generate a producer lookup request. The producer lookup request is for reading the pointer value from memory in advance of an actual producer instruction. The producer lookup request includes the virtual address of a future producer. The pointer prefetch request queuer 23 sends the producer lookup request into the memory lookup pipeline 25 in the load/store unit 9. The load/store unit 9 thereafter returns the data which is interpreted as a virtual memory address. The pointer prefetch request queuer 23 calculates the virtual address of the consumer. The pointer prefetch request queuer 23 can calculate the virtual address for the consumer by adding the displacement to the virtual address returned from the producer prefetch request. In turn, the pointer prefetch request queuer 23 uses the calculated virtual address to generate a standard prefetch request for the consumer, and sends the standard prefetch request for the consumer to the prefetch request queue 7. The standard prefetch request for the consumer has the virtual address of the consumer calculated by the pointer prefetch request queuer 23, and can also include information such as an identifier of the prefetching engine 3a. The prefetch request queue 7 can be implemented as a First-In-First-Out queue in parallel to the load queue 5 and store queue 6 to issue requests into the memory lookup pipeline. Upon sending the standard prefetch request for the consumer to the prefetch request queuer 7, the pointer prefetch request queuer 23 removes the oldest entry in the pointer prefetch request queue 33.

As mentioned above, a benefit of the first embodiment is that prefetching can be accomplished for instructions accessing objects pointed to by pointers. This increases the efficiency of a processor by avoiding the waste of processor cycles by decreasing access times for data.

### Alternative Embodiments

In the first embodiment of the pointer prefetching engine 3a described above, the enhanced stride prefetch engine 21 generates a producer prefetch request upon determining a regular repeated stride has been found. In a first alternative embodiment, the enhanced stride prefetch engine 21 can generate one or more additional producer prefetch requests upon determining that a regular repeated stride has been found.

More specifically, in the first alternative embodiment, upon determining a regular repeated stride has been found, the enhanced stride prefetch engine 21 can also generate a subsequent producer prefetch request. The enhanced stride prefetch engine 21 of the first alternative embodiment calculates a virtual address of the subsequent producer prefetch request by adding the found stride to the virtual address of the previous producer prefetch request. The enhanced stride prefetch engine 21 of the alternative embodiment can then generate the subsequent producer prefetch request including the calculated producer prefetch request and the same displacement as the previous producer prefetch request. The enhanced stride prefetch engine 21 of the alternative embodiment can then send the subsequent producer prefetch request to the pointer prefetch request queuer 23. The enhanced stride prefetch engine 21 of the alternative embodiment can repeatedly send subsequent producer prefetch requests to the pointer prefetch request queuer 23 until the total number of producer prefetch requests reaches a predetermined depth. Once the total number of producer prefetch requests reaches the predetermined depth, the enhanced stride prefetch engine 21 of the alternative embodiment can obtain a subsequent training request from the pointer-producer queuer 19.

A benefit of this first alternative embodiment of the first embodiment is that producer prefetch requests are generated sooner for predicted subsequent producer-consumer pairs, which further decreases memory access times for the predicted subsequent iterations of the producer and the consumer. The benefit is compounded when the producer and consumer are dynamically allocated data objects implemented together in a loop.

In the first embodiment of the pointer prefetching engine 3a described above, the producer-consumer linker 17 sends the training request to the pointer-producer queuer 23. In a second alternative embodiment, the producer-consumer linker 17 sends the training request directly to the enhanced stride prefetch engine 21. This feature of the second alternative embodiment can also modify the first alternative embodiment.

A benefit of this second alternative embodiment is increased efficiency in environments where only one load instruction is processed per processor cycle.

It is understood that the enhanced scheduler 15, the producer-consumer linker 17, the pointer-producer queuer 19, the enhanced stride prefetch engine 21, and the pointer prefetch request queuer 23 can be implemented in a hardware prefetcher as described above, or as a processor programmed to execute a software prefetcher based on the functions of the parts of the hardware prefetcher described above.

Method to Prefetch Pointer-Based Structures

Exemplary embodiments of a method to prefetch pointer-based structures will be described in detail below.

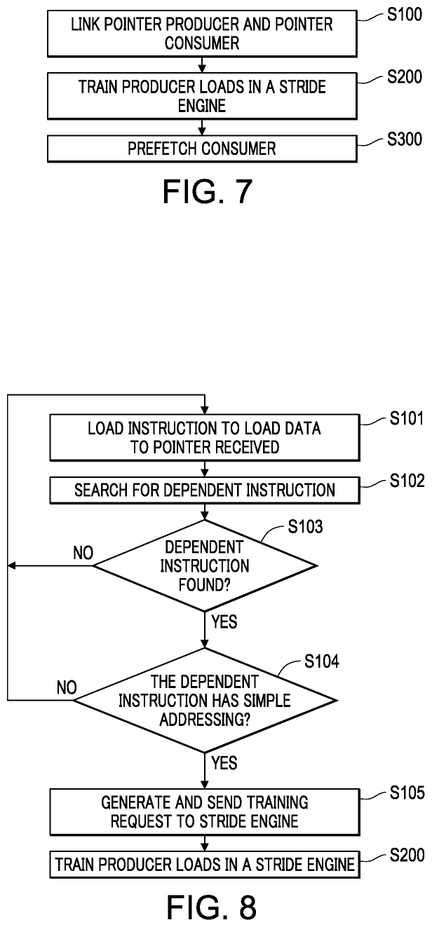

FIG. 7 is a flow chart illustrating an example of a flow of a method to prefetch pointer-based structures by the pointer prefetching engine 3a, as defined above.

As an overview of the steps of the method, first, in S100, the pointer prefetching engine 3a identifies a producer and a consumer as a producer-consumer pair. Second, in S200, the pointer prefetching engine 3a determines a stride based on the producer-consumer pair, and generates pointer prefetch requests for the producer. Third, in S300, the pointer prefetching engine 3a reads a pointer value of a pointer used by the producer from memory to find a virtual address in the memory at which the producer will load data, calculates a virtual address for the consumer by adding the displacement of the consumer to the virtual address obtained for the producer, and generates a standard prefetch request using the virtual address of the consumer for prefetching.

FIG. 8 is a flowchart illustrating an example of a flow for linking a producer and a consumer in S100. In S101, the enhanced scheduler 15 receives the wakeup signal from the load/store unit 9 after the load/store unit 9 receives a load instruction to load data to a pointer has been received. The wakeup signal instructs the enhanced scheduler 15 to search for a dependent instruction. The wakeup signal includes the destination register name of the load instruction. The load/store unit 9 speculatively sends the wakeup signal before the load instruction will be ready for processing.

In S102, the enhanced scheduler 15 searches for a dependent instruction in the scheduler queue 27.

In S103, the enhanced scheduler 15 determines whether a dependent instruction is found in the scheduler queue 27. When a dependent instruction is not found in the scheduler queue, the enhanced scheduler 15 returns to waiting for a wakeup signal in S101. When a dependent instruction is found, and the enhanced scheduler 15 determines that the dependent instruction is a load instruction or a store instruction, the enhanced scheduler 15 sends the agen-valid signal 28a to the load/store unit 9. Upon receipt of the agen-valid signal 28a, the load/store unit 9 marks the load instruction in the load queue 5 as ready for cache/memory lookup. Also in response to the enhanced scheduler 15 finding the dependent instruction in the scheduler queue 27, the enhanced scheduler 15 generates and sends a check status signal 28d to the load/store unit 9. Upon receipt of the check status signal 28d, the load/store unit 9 checks the status of the load instruction to determine whether the dependent instruction is still ready for cache/memory lookup. After the scheduler 9 sends the check status signal 28d to the load/store unit 9, the flow proceeds to S104.

In S104, the enhanced scheduler 15 inspects the syntax of the dependent instruction by parsing the destination address out from the syntax (the arguments 27c and 27d) of the dependent instruction. The enhanced scheduler 15 determines whether the destination address is a simple address. Upon determining that the destination address is a simple address, the enhanced scheduler 15 generates a consumer-candidate-valid signal 28i. The consumer-candidate-valid signal 28i identifies the dependent instruction is a valid candidate to be a consumer. In other words, the consumer-candidate-valid signal 28i confirms that the dependent instruction is appropriate for pointer prefetching according to the method implemented by the pointer prefetching engine 3a. After sending the consumer-candidate valid signal to the load/store unit 9, the flow proceeds to S105.

In S105, a producer-consumer linker 17 receives the agen-valid signal 28a, the check status signal 28d, and the consumer-candidate-valid signal 28i. Upon the producer-consumer linker 17 receiving the agen-valid signal 28a from the enhanced scheduler 15, the producer-consumer linker 17 identifies the dependent instruction as a consumer in a producer-consumer pair. Similarly, upon the producer-consumer linker 17 receiving the check status signal 28d from the enhanced scheduler 15, the producer-consumer linker 17 identifies the load instruction as a producer in the producer-consumer pair. Upon the producer-consumer linker 17 receiving the consumer-candidate-valid signal 28i from the enhanced scheduler 15, the producer-consumer linker 17 is thereby notified that the producer-consumer pair is a valid candidate for training the enhanced stride prefetch engine 21.

Upon notification that the producer-consumer pair is a valid candidate, the producer-consumer linker 17 generates a training request. The training request includes the PC of the producer, the virtual address of the producer, and the displacement of the consumer. The producer-consumer linker 17 retrieves the program counter (PC) and the virtual address of the producer from the load queue 5, and determines the displacement of the consumer after inspecting a syntax of the consumer. For example, the producer-consumer linker 17 can determine a displacement of the consumer by parsing the syntax of the arguments 27c and 27d of the consumer to identify a constant displacement referenced in conjunction with the virtual address of the pointer of the load instruction.

Upon the producer-consumer linker 17 determining the displacement of the consumer, the producer-consumer generates a training request including the retrieved PC of the producer, the retrieved virtual address of the producer, and the determined displacement of the consumer. The producer-consumer linker 17 then sends the training request to the pointer-producer queuer 19, which queues the training request until the enhanced stride prefetch engine 21 is ready to process the training request in S200.

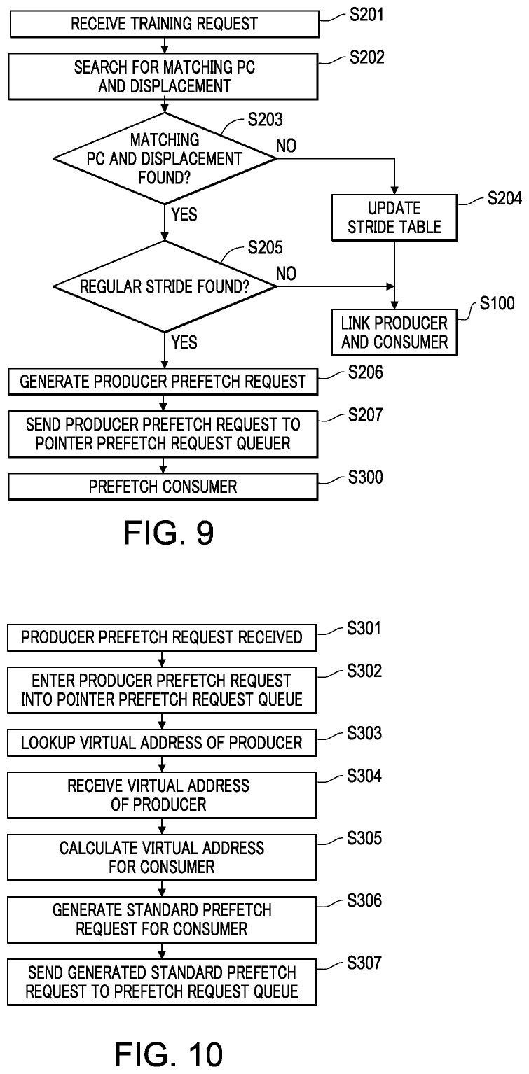

FIG. 9 is a flowchart illustrating an example of a flow of S200 for training producer-consumer pairs in an enhanced stride prefetch engine 21. In S201, the enhanced stride prefetch engine 21 receives a training request from the pointer-producer queuer 19. Upon receiving the training request from the pointer-producer queuer 19, the flow proceeds to S202.

In S202, the enhanced stride prefetch engine 21 searches the tag/signatures 31a of the stride table 31 for a tag/signature 31a simultaneously having the PC of the producer and the displacement indicated by the training request. When no tag/signature 31a matching the training request is found by the enhanced stride prefetch engine 21, the flow proceeds to S204.

In S204, the enhanced stride prefetch engine 21 allocates a new entry in the stride table 31. The new entry's identifier includes the PC of the producer and the displacement of the consumer as a tag/signature of the new entry. In addition, the enhanced stride prefetch engine 21 stores and associates the virtual address of the pointer of the producer in a field of the new entry as a virtual address 31d.

The new entry's identifier includes the PC of the producer and displacement of the consumer, as indicated in the training request, as a tag/signature of the new entry. In addition, the enhanced stride prefetch engine 21 stores and associates the virtual address of the producer of the received training request in a field of the new entry as a virtual address 31d. After the new entry is complete in the stride table 31 is complete, the flow returns to S100.

If the enhanced stride prefetch engine 21 finds a matching tag/signature 31a in the stride table 31 in S203, the enhanced stride prefetch engine 21 has now received a training request for the producer-consumer pair for at least the second time, and the flow proceeds to S205. In S205, the enhanced stride prefetch engine 21 calculates a current stride by comparing the virtual address of the pointer of the producer included in the training request to the virtual address 31d associated with the matching tag/signature 31a. By non-limiting example, the stride engine subtracts the virtual address 31d from the virtual address included in the training request. The enhanced stride prefetch engine 21 then increments the number of instances 31f associated with the matching tag/signature 31a, replaces the virtual address 31a associated with the matching tag/signature 31a with the virtual address included in the training request, and compares the current stride with the per-PC stride(s) 31g of the stride unit(s) 31f associated with the matching tag/signature 31a. When a matching per-PC stride 31i is found, the frequency 31h of the per-PC stride associated with the matching stride unit 31h is incremented by 1. When no matching per-PC stride 31i is found, a new stride unit 31h is added associated with the matching tag/signature 31a to the stride table 31. The new stride unit 31h includes the current stride as the per-PC stride 31i of the new stride unit 31h, and the frequency 31h is initialized at a value of 1.

The enhanced stride prefetch engine 21 then determines whether a regular repeated stride has been found. By non-limiting example, the enhanced stride prefetch engine 21 can determine whether a regular repeated stride has been found by determining whether the absolute value of the frequency of the incremented per-PC stride 31j is greater than a predetermined threshold value. In an alternative non-limiting example, the enhanced stride prefetch engine 21 can determine whether a regular repeated stride has been found by determining whether the ratio of the frequency of the incremented per-PC stride 31j to the associated number of instances 31f is greater than a predetermined threshold ratio. As made apparent in light of this disclosure, other appropriate approaches to determining whether a regular repeated stride has been found can be implemented by the enhanced stride prefetch engine 21.

When the enhanced stride prefetch engine 21 determines that a regular repeated stride has not been found in S205, the flow returns to S100.

When the enhanced stride prefetch engine 21 determines that a regular repeated stride has been found in S205, the flow proceeds to S206. In S206, the enhanced stride prefetch engine 21 generates a producer prefetch request. The producer prefetch request is based on the virtual address of the producer and also includes the displacement of the consumer, as received with the training request.

In subsequent S207, the enhanced stride prefetch engine 21 sends the producer prefetch request to the pointer prefetch request queuer 23, and then the flow proceeds to S300.

FIG. 10 is a flowchart illustrating an example of a flow of S300 for prefetching for a consumer by the pointer prefetching engine 3a.

In S301, the pointer prefetch request queuer 23 receives the producer prefetch request from the enhanced stride prefetch engine 21. Upon receiving the producer prefetch request, the flow continues to S302 in which the pointer prefetch request queuer 23 inserts a new entry into the pointer prefetch request queue 33 including the virtual address and the displacement included in the producer prefetch request.

In subsequent S303, the pointer prefetch request queuer 23 generates a producer lookup request. The producer lookup request is for reading the pointer value from memory in advance of an actual producer instruction. The producer lookup request includes the virtual address of a future producer.

Next, in S304, the pointer prefetch request queuer 23 sends the producer lookup request the load/store unit 9 for entry into the memory lookup pipeline 25. The load/store unit 9 thereafter returns the data which is interpreted as a virtual memory address.

In S306, the pointer prefetch request queuer 23 calculates the virtual address necessary to execute the consumer. The pointer prefetch request queuer 23 adds the displacement 33b to the virtual address returned from the producer prefetch request. In turn, the pointer prefetch request queuer 23 uses the calculated virtual address to generate a standard prefetch request for the consumer.

The final step of the exemplary flow is 307, in which the pointer prefetch request queuer 23 sends the standard prefetch request for the consumer to the prefetch request queue 7. Upon sending the standard prefetch request queue for the consumer to the prefetch request queue 7, the pointer prefetch request queuer 23 removes the oldest entry in the pointer prefetch request queue 33.

As discussed above, the above-mentioned exemplary embodiments of the pointer prefetching engine and method are not limited to the examples and descriptions herein, and may include additional features and modifications as would be within the ordinary skill of a skilled artisan in the art. For example, the alternative or additional aspects of the exemplary embodiments may be combined as well. The foregoing disclosure of the exemplary embodiments has been provided for the purposes of illustration and description. This disclosure is not intended to be exhaustive or to be limited to the precise forms described above. Obviously, many modifications and variations will be apparent to artisans skilled in the art. The embodiments were chosen and described in order to best explain principles and practical applications, thereby enabling others skilled in the art to understand this disclosure for various embodiments and with the various modifications as are suited to the particular use contemplated.

1. A processor including a pointer prefetching engine comprising:
a scheduler programmed to receive a wakeup signal based on a load instruction loading data to a memory address identified by a pointer, identify a dependent instruction based on the wakeup signal, and validate the dependent instruction;
a linker programmed to identify a producer-consumer pair of instructions including the load instruction and the dependent instruction based on the validation of the dependent instruction, and generate a training request based on the producer-consumer pair of instructions;
a stride engine programmed to determine a regular repeated stride of the producer-consumer pair of instructions based on the training request, and generate a producer prefetch request based on the regular repeated stride; and
a producer prefetch request queuer programmed to issue the producer prefetch request to lookup cache/memory, modify a virtual address returned from the producer prefetch request lookup, and generate a standard prefetch request for the dependent instruction including the modified virtual address.

2. The processor of claim 1, wherein the pointer prefetching engine further includes:
a pointer-producer queuer programmed to receive a plurality of training requests including the training request from the linker, and send each of the plurality of training requests to the stride engine in an order each training request was received.

3. The processor of claim 1, wherein:
the scheduler is further programmed to send a consumer-candidate-valid signal to the linker upon validating the dependent instruction, and
the linker generates the training request in response to receiving the consumer-candidate-valid signal.

4. The processor of claim 3, wherein:
the scheduler is further programmed to send an agen-valid signal and a check status signal to the linker upon identifying the dependent instruction, the agen-valid signal indicating an address generation for the identified dependent instruction, and the check status signal requesting a status of the load instruction in a memory lookup pipeline,
the linker is further programmed to:
identify a consumer of the producer-consumer pair in response to receiving the agen-valid signal,
identify a producer of the producer-consumer pair, and retrieve a program counter of the load instruction and the memory address identified by the pointer of the load instruction, in response to receiving the check status signal, and
determine a displacement of the dependent instruction based on the memory address identified by the pointer of the load instruction in response to receiving the consumer-candidate-valid signal, and
the training request includes the program counter of the load instruction, the memory address identified by the pointer of the load instruction, and the displacement of the dependent of the dependent instruction.

5. The processor of claim 1, wherein the training request includes a program counter of the load instruction, the memory address identified by the pointer of the load instruction, and a displacement of the dependent instruction with respect to the memory address identified by the pointer of the load instruction.

6. The processor of claim 1, wherein the producer prefetch request includes a displacement of the dependent instruction with respect to the memory address identified by the pointer of the load instruction and the memory address identified by the pointer of the load instruction.

7. The processor of claim 1, wherein the stride engine is further programmed to generate a plurality of producer prefetch requests based on the regular repeated stride.

8. A method comprising:
receiving a wakeup signal based on a load instruction loading data to a memory address identified by a pointer;
identifying a dependent instruction based on the wakeup signal;
validating the dependent instruction;
identifying a producer-consumer pair of instructions including the load instruction and the dependent instruction based on the validation of the dependent instruction;
generating a training request based on the producer-consumer pair of instructions;
determining a regular repeated stride of the producer-consumer pair of instructions based on the training request;
generating a producer prefetch request based on the regular repeated stride;
issuing the producer prefetch request to lookup cache/memory
modifying a virtual address returned from the producer prefetch request lookup, and
generating a standard prefetch request for the dependent instruction including the modified virtual address.

9. The method of claim 8, further including:
queuing a plurality of training requests including the training request.

10. The method of claim 8, wherein:
validating the dependent instruction includes generating a consumer-candidate-valid signal, and
the training request is generated in response to the consumer-candidate-valid signal.

11. The method of claim 10, further comprising:
generating an agen-valid signal and a check status signal to the upon identifying the dependent instruction, the agen-valid signal indicating an address generation for the identified dependent instruction, and the check status signal requesting a status of the load instruction in a memory lookup pipeline;
identifying a consumer of the producer-consumer pair in response to receiving the agen-valid signal;
identifying a producer of the producer-consumer pair;
retrieving a program counter of the load instruction and the memory address identified by the pointer of the load instruction, in response to receiving the check status signal; and
determining a displacement of the dependent instruction based on the memory address identified by the pointer of the load instruction in response to receiving the consumer-candidate-valid signal, wherein
the training request includes the program counter of the load instruction, the memory address identified by the pointer of the load instruction, and the displacement of the dependent of the dependent instruction.

12. The method of claim 8, wherein the training request includes a program counter of the load instruction, the memory address identified by the pointer of the load instruction, and a displacement of the dependent instruction with respect to the memory address identified by the pointer of the load instruction.

13. The method of claim 8, wherein the producer prefetch request includes a displacement of the dependent instruction with respect to the memory address identified by the pointer of the load instruction and the memory address identified by the pointer of the load instruction.

14. The method of claim 8, further comprising:
generating a plurality of producer prefetch requests based on the regular repeated stride.
